(19) United States
(12) Patent Application Publication
(10) Pub. No.: US 2010/0327225 A1
(43) Pub. Date: Dec. 30, 2010

(54) PACKAGED PARTICULATE BLEACHING COMPOSITIONS

(76) Inventors: Giulia Ottavia Bianchetti, Rome (IT); Gloria Dicapua, Rome (IT); Andrea Esposito, Rome (IT); Sarah Germana, Rome (IT); Vincenzo Guida, Rome (IT); Luca Sarcinelli, Cerveteri (IT)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/823,537

(22) Filed: Jun. 25, 2010

(30) Foreign Application Priority Data
Jun. 30, 2009 (EP) 09164131.6

(51) Int. Cl. C09K 3/00

(52) U.S. Cl. 252/188.21; 252/188.1

(57) ABSTRACT

The present invention relates to a packaged particulate bleaching composition the composition comprising:
a. from 1% to 30% by weight of a bleach activator, and
b. from 10% to 80% by weight of an oxygen bleach,
   characterized in that the composition is packaged in a packaging system having a Moisture Vapour Transfer Rate of less than 0.1 g/m2/day as measured by ASTM Standard E-96-53T.

### TECHNICAL FIELD

The present invention relates to a packaged particulate bleaching composition, and further relates to the use of a packaging system to reduce the production of malodorous decomposition products coming from particulate bleaching compositions containing bleach activators.

### BACKGROUND OF THE INVENTION

Bleach-containing compositions for bleaching various surfaces, such as fabrics, are well known in the art. Commonly encountered particulate bleaching compositions are mainly based on hypochlorite bleaches or on oxygen bleaches such as peroxygen bleaches.

Particulate bleaching compositions based on oxygen bleaches are based on so-called persalt bleaches such as sodium perborate, in its various hydrate forms, or on sodium percarbonate. Such persalt bleaches are sources of hydrogen peroxide when used in aqueous washing conditions. However, such oxygen bleaching compositions are sometimes considered as less efficient than hypochlorite bleaches composition. Typically, to overcome such poor bleaching performance of hydrogen peroxide, persalt bleaches are formulated in granular compositions with bleach activators.

However, a major drawback associated with the use of bleach activators is the malodor they generate, mainly during storage. Not only the compositions itself have an unpleasant smell but the malodor remains sometimes noticeable on surfaces or fabrics which have been treated with said composition. Indeed, bleach activators decompose rapidly when stored in a moist and/or warm atmosphere and result in the creation of an unpleasant smell.

Formulators have tried to solve that problem by designing perfumed bleaching composition. However, this has been difficult for many reasons; mainly for the fact that very few perfume components are stable in such an oxidative environment. Furthermore, the malodor generated by bleach activator is very strong and difficult to mask.

There is, thus, a need to have improve bleaching composition with excellent bleaching performances which are attractive to consumers, i.e. which do not have such unpleasant odor.

The problem of the influence of moisture level on bleaching composition has been addressed in EP-A-0 503 221. However, it was found that, while the moisture level can relatively be well controlled upon making of the detergent composition, it is quite difficult to control its evolution during storage, where moisture is almost inevitably picked up.

It has now been found that the storage stability of bleach activator can be quite satisfactorily controlled, not only in high moisture but also in high temperature environments, by the use of a specific packaging system.

An advantage of the bleaching compositions according to the present invention is, thus, that they do not generate malodor. Indeed, the oxidizing agent is not decomposed upon storage of said composition. The compositions of the present invention provide thus excellent bleaching performances when used in any laundry application, e.g., as a laundry detergent, a laundry additive and/or a laundry pretreater.

Another advantage of the compositions of the present invention is that they exhibit also effective stain removal performance on various stains including enzymatic stains and/or greasy stains.

A further advantage of the compositions of the present invention is that the particulate bleach additives herein are suitable for the bleaching of different types of fabrics including natural fabrics, (e.g., fabrics made of cotton, and linen), synthetic fabrics such as those made of polymeric fibres of synthetic origin (e.g., polyamide-elasthane) as well as those made of both natural and synthetic fibres. For example, the particulate bleach additives of the present invention herein may be used on synthetic fabrics despite a standing prejudice against using bleaches on synthetic fabrics, as evidenced by warnings on labels of clothes and commercially available bleaching compositions like hypochlorite-containing compositions.

### SUMMARY OF THE INVENTION

The present invention relates to a packaged particulate bleaching composition, the composition comprising:
a. from 1% to 30% by weight of a bleach activator, and
b. from 10% to 80% by weight of an oxygen bleach,
   wherein the composition is packaged in a packaging system having a Moisture Vapour Transfer Rate of less than 0.1 g/m²/day.

The present invention further relates to a process of packaging a composition to reduce the production of malodorous decomposition products from the composition comprising:
a. from 1% to 30% by weight of a bleach activator, and
b. from 10% to 80% by weight of an oxygen bleach,
   wherein the composition is packaged in a packaging system having a Moisture Vapour Transfer Rate of less than 0.1 g/m²/day.

### DETAILED DESCRIPTION OF THE INVENTION

The method of the present invention avoids the production of malodor coming from bleaching compositions. The bleaching compositions are particulate bleaching compositions and comprise from 1% to 30% by weight of a bleach activator, and the compositions comprise from 10% to 80% by weight of an oxygen bleach, more preferably a peroxygen source, even more preferably hydrogen a peroxide source. The presence of such bleach activator is important in view of providing improved bleaching performances. According to the method of the present invention, it is further provided that the packaging system, in which the composition is packaged, has a Moisture Vapour Transfer Rate of less than 0.1 g/m²/day.

### The Packaging System

The packaging system of the present invention can be of any forms and include any conventional packaging systems such as bottles or boxes.

The packaging system herein consists of at least one unit being the recipient for the compositions of the present invention; such a unit is typically a consumer unit such as a bottle or a box containing the composition of the invention and designed to be used/stored as such in the consumer homes.

The packaging system can, if necessary in view of obtaining the derived Moisture Vapour Transfer Rate, be coated either on the inside on to the outside with a layer of material, typically metal or plastic laminate, providing to the unit the Moisture Vapour Transfer Rate characteristics of the invention.

The packaging system herein can be printed as described above, and/or be coated with materials such as lacquers ensuring barrier properties.

The packaging system herein can be made of any materials, and thickness of materials, which provides the required Moisture Vapour Transfer Rate characteristics of the invention.

In a preferred embodiment, the packaging systems are containers made of commonly used plastic materials. Typical plastic materials used for producing the packaging systems according to the present invention include polyvinylchloride (PVC), polyethylene terephthalate (PET), polypropylene (PP), polylactic acid (PLA), low or high density polyethylene (LDPE or HDPE) and polystyrene (PS). Preferably the material of the packaging system is a thermoplastic polyolefin selected from polyethylene, polypropylene or co-polymers thereof; more preferably the packaging system is made of low or high density polyethylene (LDPE or HDPE), even more preferably high density polyethylene (HDPE). HDPE having a thickness of 2 mm typically has a Moisture Vapour Transfer Rate of about 0.6 to about 0.1 g/m²/day.

Packaging systems, according to the present invention, have the advantage of being able to contain particulate bleaching composition comprising from 1% to 30% by weight of bleach activator and from than 10% to 80% of oxygen bleach or mixtures thereof without producing any unpleasant odor.

An important feature of the packaging system of the present invention is that the packaging system has a Moisture Vapour Transfer Rate of less than 0.1 g/m²/day. According to this specific Moisture Vapour Transfer Rate, the H₂O permeability is such that H₂O will not be able to interact with the composition, and especially with the bleach activator, and thus there will not be malodour generated.

Packaging systems of the present invention generally require having some form of closure mechanism to enclose and protect the composition and to facilitate extraction, dosing and application. These closures take a wide range of formats, are most commonly made from polyolefins, preferably polypropylene. These items are also commonly made from polyolefins, preferably polypropylene (PP), Low or High density polyethylene (LDPE or HDPE), or polyestertetraphtalate (PET).

One-piece caps with or without living hinges are also a preferred method of closure for a packaging system. Caps with living hinges are preferred.

These closures have a nozzle section and a cap section which is attached by a thin section of the same part. This joint is preferably made into a living hinge which forces the cap to flip back or to the nozzle from the other position when a small force is applied. These closures are low-cost to produce as they consist of just one piece, and are particularly advantageous for use on products that require one-handed use, such as shampoos and dish detergents. Preferably the closure system of the packaging system contains a screw system.

Such closure systems are preferred as they reinforce the protection against moisture and the help to avoid the generation of malodour.

The packaging system containing the composition of the present invention is characterized in that it contains at least one unit having a Moisture Vapour Transfer Rate, in the range of less than 0.1 g/m2/day.

The Moisture Vapour Transfer Rate can be measured by known methods such as described in ASTM Standard E-96-53T, test for measuring Water Vapor transmission of Materials in Sheet form. Alternatively Moisture Vapour Transfer Rate may be measured by TAPPI Standard T464 m-45, Water Vapor Permeability of Sheet Materials at high temperature and humidity.

The method used in the context of the present invention is referred to as the procon test, using a Permatran-W TWIN equipment.

The procedure is as follows:

### Equipment

Aluminum test cups with lids (4″ and 6″ diameter)
Template 1 (for cutting sample)-Template 2 (for applying wax)
Electric hotplate
Laboratory oven with temperature control (accuracy+/−1 degree C.)
Laboratory cabinet with humidity control (accuracy+/−2% R.H.)
Microcrystalline wax (c.g. Mobel Oil Wax 2305 or equivalent)
Calcium chloride, anhydrous, granular, 8 mesh
Petrolatum
Electric vessel with thermostat for melting wax
Cutting pad
Scissors or circular cutting knife
Laboratory balance (i.e. Mettler K-7, Mikrowa type FW-31-6, etc.) with accuracy of +/−0.05 g.

### Preparation of Materials

A test sample is cut out from the material to be tested. Another test sample from uniform protective sheet of material of known MVTR is used as control (e.g. bitumen laminated liner or wax-laminated board).

Test procedure
1) The wax is heated in the electric vessel to 90-110° C. The test cups are heated in the oven or hot plate for ½ hour at about 90° C. One test cup is removed from the oven at a time, and the cups are filled with calcium chloride up to ⅔ of cup ring height, petrolatum is applied sparingly to the beveled edge of the template 2. The base of the template 2 is wiped dry where it comes in contact with the test sample. The sample is centered in the cup. The template 2 is placed over the sample and centered with respect to the cup. Melted wax is poured into the annular space formed by the beveled edge of the template 2 and the cup rim. When the wax has solidified, the template 2 is removed using a gentle twisting motion. The cup assembly is weighted to the nearest 0.05 gram before being placed in the test atmosphere. The cups are stored at 35° C./80% eRH.
2) After being left two days in the humidity cabinet, the cups are weighed every 24 hours interval until a constant weight gain is obtained on three successive weightings (maximum deviation 0.25 gram). The cups are weighed immediately after removal from the humidity cabinet, and are covered with an aluminum lid when moved from cabinet to balance. All weightings are recorded and the daily weight gain for each cup is calculated. The MVTR is recorded in g/m²/24 hours and calculated as follows:
a) effective area of sample: 66.6 cm² (4″ diameter cups) 3600×XY g/m²/24 hours
b) effective area of sample: 133 cm² (6″ diameter cups) 1800×XY g/m²/24 hours where X=total weight gain in grams and Y=time in hours.
   (both calculated on the basis of 3 successive periods with a daily constant weight gain).
   Depending on the execution of the present system, the amount of detergent composition contained in the packaging systems herein can vary from 250 g (individual small consumer units) to 20 kg (bundles consumer units).

### The Particulate Bleach Additive Composition

The particulate bleaching compositions herein are so called particulate bleach additive compositions. These compositions are suitable for use in conjunction with a conventional laundry detergent and, in particular, with particulate laundry detergents to treat (stained) fabrics. The terms “additive” or “through-the-wash (bleaching) composition” refer to compositions that are preferably employed in the specific process of treating, preferably bleaching, fabrics as encompassed by the present invention.

Indeed, additive compositions are added together with a conventional laundry detergent (preferably particulate laundry detergent) into a washing machine and are active in the same wash-cycle. By contrast, so-called ‘spotter’ or ‘pretreater’ compositions that are applied, mostly undiluted, onto fabrics prior to washing or rinsing the fabrics and left to act thereon for an effective amount of time. Furthermore, so-called ‘soakers’ or ‘rinse-added’ compositions are contacted, mostly in diluted form, with fabrics prior or during rinsing of fabrics with water.

The bleach additive compositions herein are particulate compositions. By “particulate” it is meant herein powders, pearls, granules, tablets and the like. Particulate compositions are preferably applied onto the fabrics to be treated dissolved in an appropriate solvent, typically water.

The particulate bleach additive composition herein have a pH measured at 25° C., preferably of at least, with increasing preference in the order given, 0.1, 0.5, 1, 1.5, 2, 2.5, 3, 3.5, 4, 4.5, 5, 5.5, 6, 6.5, 7, when diluted into 1 to 500 times its weight of water. Independently, particulate bleach additive composition herein have a pH measured at 25° C., preferably of no more than, with increasing preference in the order given, 12, 11.5, 11, 10.5, 10, 9.5, 9, 8.5 or 8, when diluted into 1 to 500 times its weight of water.

The compositions of the present invention are granular compositions. These compositions can be made by a variety of methods well known in the art, including dry-mixing, spray drying, agglomeration and granulation and combinations thereof. The compositions herein can be prepared with different bulk densities, from conventional granular products to so called “concentrated” products (i.e., with a bulk density above 600 g/l).

### The Oxygen Bleach

As an essential ingredient, the compositions of the present invention comprise an oxygen bleach or a mixture thereof. Preferably said oxygen bleach is a peroxygen source, more preferably an hydrogen peroxide source.

Examples of the addition of hydrogen peroxide compounds include inorganic perhydrate salts. Examples of inorganic perhydrate salts include perborate, percarbonate, perphosphate and persilicate salts. The inorganic perhydrate salts are normally the alkali metal salts. The alkali metal salts of percarbonate, perborate or mixtures thereof, are the preferred inorganic perhydrate salts for use herein. Preferred alkali metal salt of percarbonate is sodium percarbonate.

In a preferred embodiment of the present invention, the oxygen bleach is a peroxygen source, preferably an alkali metal salt of percarbonate, more preferably sodium percarbonate. Other suitable oxygen bleaches include persulphates, particularly potassium persulphate K₂S₂O₈ and sodium persulphate Na₂S₂O₈.

The alkali metal percarbonate bleach is usually in the form of sodium salt. Sodium percarbonate is a compound having a formula corresponding to 2Na₂CO₃ 3H₂O₂. To enhance storage stability the percarbonate bleach can be coated with, e.g., a further mixed salt of an alkali metal sulphate and carbonate. Such coatings together with coating processes have previously been described in GB 1466799. The weight ratio of the mixed salt coating material to percarbonate lies in the range from 1:2000 to 1:4, more preferably from 1:99 to 1:9, and most preferably from 1:49 to 1:19. Preferably, the mixed salt is of sodium sulphate and sodium carbonate which has the general formula Na₂SO₄.n.Na₂CO₃ wherein n is from 0.1 to 3, preferably n is from 0.3 to 1.0 and most preferably n is from 0.2 to 0.5.

Commercially available carbonate/sulphate coated percarbonate bleach may include a low level of a heavy metal sequestrant such as EDTA, 1-hydroxyethylidene 1,1-diphosphonic acid (HEDP) or an aminophosphonate, that is incorporated during the manufacturing process.

Preferred heavy metal sequestrants for incorporation as described herein above include the organic phosphonates and amino alkylene poly(alkylene phosphonates) such as the alkali metal ethane 1-hydroxy diphosphonates, the nitrilo trimethylene phosphonates, the ethylene diamine tetra methylene phosphonates and the diethylene triamine penta methylene phosphonates.

The compositions of the present invention comprise from 10% to 80% by weight of the total composition of an oxygen bleach or mixtures thereof, preferably from 15% to 70% and more preferably from 20% to 60%.

Preferably, the compositions herein typically contain from 15% to 70% by weight, preferably from 20% to 60% by weight of an alkali metal percarbonate bleach in the form of particles having a mean size from 250 to 900 micrometers, preferably 500 to 700 micrometers.

### Bleach Activators

Typically to overcome poor bleaching performance of oxygen bleaches, persalt bleaches are formulated in granular compositions with so-called bleach activators. The bleach activators are species that react with hydrogen peroxide to form a peroxyacid or peracid.

Thus, as another essential ingredient, the compositions according to the present invention comprise an oxygen bleach or a mixture thereof.

In a preferred embodiment, the bleach activator used in the liquid bleach composition has the general formula:

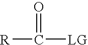

wherein R is an alkyl group, linear or branched, containing from about 1 to 11 carbon atoms and LG is a suitable leaving group. As used herein, a “leaving group” is any group that is displaced from the bleach activator as consequence of nucleophilic attack on the bleach activator by the perhydroxide anion, i.e. perhydrolysis reaction.

Generally, a suitable leaving group is electrophilic and is stable such that the rate of the reverse reaction is negligible. This facilitates the nucleophilic attack by the perhydroxide anion. The leaving group must also be sufficiently reactive for the reaction to occur within the optimum time frame, for example during the wash cycle. However, if the leaving group is too reactive, the bleach activator will be difficult to stabilize. In the past, those skilled in the art have not been successful in formulating an aqueous liquid bleach having the desired stability for a practical shelf-life.

These characteristics are generally paralleled by the pKa of the conjugate acid of the leaving group, although exceptions to this convention are known. The conjugate acid of the leaving group in accordance with the present invention preferably has a pKa in a range from about 4 to about 13, more preferably from about 6 to about 11, and most preferably from about 8 to about 11.

Preferably, the leaving group has the formula:

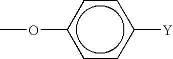

wherein Y is selected from the group consisting of SO₃⁻M⁺, COO⁻M⁺, SO₄⁻M⁺, PO₄⁻M⁺, PO₃⁻M⁺. (N⁺R²₃)X⁻ and 0←N(R²₂), M is a cation and X is an anion, both of which provide solubility to the bleach activator, and R² is an alkyl chain containing from about 1 to about 4 carbon atoms or H. In accordance with the present invention, M is preferably an alkali metal, with sodium being most preferred. Preferably, X is a hydroxide, methylsulfate or acetate anion.

Other suitable leaving groups have the following formulas

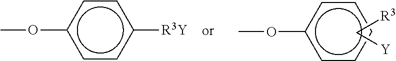

wherein Y is the same as described above and R³ is an alkyl chain containing from about 1 to about 8 carbon atoms, H or R².

While numerous bleach activators as described above are suitable for use in the present liquid bleach composition, a preferred bleach activator has the formula:

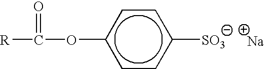

wherein R is an alkyl chain, linear or branched, containing from 1 to 11 carbon atoms. More preferably, R is an alkyl chain, linear or branched, containing from 3 to 11, even more preferably from 8 to 11.

Most preferably, according to the present invention, the bleach activator has the formula:

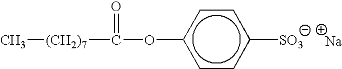

which is also referred to as sodium n-nonyloxybenzene sulfonate (hereinafter referred to as “NOBS”).

This bleach activator and those described previously may be readily synthesized by well known reaction schemes or purchased commercially, neither of which is more preferred. Those skilled in the art will appreciate that other bleach activators beyond those described herein which are readily water-soluble can be used in the present bleach composition without departing from the scope of the invention.

Typically, the compositions of the present invention might comprise from 1% to 30% by weight of the total composition of a bleach activators, preferably from 2% to 20% and more preferably from 3% to 10%.

The bleaching mechanism generally, and the surface bleaching mechanism in particular, in the washing solution are not completely understood. While not intending to be limited by theory, however, it is believed that the bleach activator undergoes nucleophilic attack by a perhydroxide anion, for example from aqueous hydrogen peroxide, to form a percarboxylic acid. This reaction is commonly referenced in the art as perhydrolysis.

A second species present in the washing solution is the diacylperoxide (also referred to herein as “DAP”). It is imperative that some DAP production is present in order to improve bleaching of specific stains such as, for example, those stains caused by spaghetti sauce or barbecue sauce. The peroxyacid acids are particularly useful for removing dingy soils from textiles. As used herein, “dingy soils” are those which have built up on textiles after numerous cycles of usage and washing and thus, cause the white textile to have a gray or yellow tint. Accordingly, the bleaching mechanism herein preferably produces an effective amount of peroxyacid and DAP to bleach both dingy stains as well as stains resulting from spaghetti and the like.

Further, it is believed that bleach activators within the scope of the invention render the peroxygen bleaches more efficient even at bleach solution temperatures wherein the bleach activators are not necessary to activate the bleach, for example at temperatures above 60° C. As a consequence, less peroxygen bleach is required to obtain the same level of surface bleaching performance as compared with peroxygen bleach alone.

Preferred mixtures of bleach activators herein comprise n-nonanoyloxybenzene-sulphonate (NOBS) together with a second bleach activator having a low tendency to generate diacyl peroxide, but which delivers mainly peracid.

Said second bleach activators may include tetracetyl ethylene diamine (TAED), acetyl triethyl citrate (ATC), acetyl caprolactam, benzoyl caprolactam and the like, or mixtures thereof. Indeed, it has been found that mixtures of bleach activators comprising n-nonanoyloxybenzene-sulphonate and said second bleach activators, contribute to further boost particulate soil removal performance while exhibiting at the same time good performance on diacyl peroxide sensitive soil (e.g., beta-carotene) and on peracid sensitive soil (e.g., body soils).

### Optional Ingredients

The compositions herein may further comprise a variety of other optional ingredients such as: surfactants, fillers, chelating agents, radical scavengers, antioxidants, stabilisers, builders, soil suspending polymer, polymeric soil release agents, dye transfer inhibitor, solvents, suds controlling agents, suds booster, brighteners, perfumes, pigments, dyes and the like.

### Surfactants

The compositions of the present invention may comprise surfactants or a mixture thereof as a highly preferred though optional ingredient

The compositions will comprise from 0.01% to 20%, preferably from 0.1% to 15% and more preferably from 0.5% to 8% by weight of the total composition of surfactant or a mixture thereof.

Suitable surfactants for use herein include any nonionic, anionic, zwitterionic, cationic and/or amphoteric surfactants or mixture thereof. Particularly suitable surfactants for use herein are nonionic surfactants such as alkoxylated nonionic surfactants and/or polyhydroxy fatty acid amide surfactants and/or amine oxides and/or zwitterionic surfactants like the zwitterionic betaine surfactants described herein after.

Suitable anionic surfactants include alkyl sulfate surfactant. Preferred alkyl sulfate surfactants include water soluble salts or acids of the formula ROSO₃M wherein R is preferably a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperidinium cations and quarternary ammonium cations derived from alkylamines such as ethylamine, diethylamine, triethylamine, and mixtures thereof, and the like). Typically, alkyl chains of C₁₂₋₁₆ are preferred for lower wash temperatures (e.g., below about 50° C.) and C₁₆₋₁₈ alkyl chains are preferred for higher wash temperatures (e.g., above about 50° C.).

Suitable anionic surfactants include Alkyl Alkoxylated Sulfate Surfactant. Preferred Alkyl Alkoxylated Sulfate Surfactant include water soluble salts or acids of the formula RO(A)ₘSO₃M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl-, trimethyl-ammonium and quaternary ammonium cations, such as tetramethyl-ammonium, dimethyl piperidinium and cations derived from alkanolamines such as ethylamine, diethylamine, triethylamine, mixtures thereof, and the like.

Preferred surfactants for use in the compositions according to the present invention are the alkyl sulfates, alkyl alkoxylated sulfates, and mixtures thereof.

Other preferred surfactants for use in the compositions according to the present invention are acyl sarcosinates surfactants.

Suitable nonionic surfactants include compounds produced by the condensation of alkylene oxide groups (hydrophilic in nature) with an organic hydrophobic compound, which may be aliphatic or alkyl aromatic in nature. The length of the polyoxyalkylene group which is condensed with any particular hydrophobic group can be readily adjusted to yield a water-soluble compound having the desired degree of balance between hydrophilic and hydrophobic elements.

Preferred for use in the present invention are nonionic surfactants such as the polyethylene oxide condensates of alkyl phenols, e.g., the condensation products of alkyl phenols having an alkyl group containing from about 6 to 16 carbon atoms, in either a straight chain or branched chain configuration, with from about 4 to 25 moles of ethylene oxide per mole of alkyl phenol.

Preferred nonionic surfactants are the water-soluble condensation products of aliphatic alcohols containing from 8 to 22 carbon atoms, in either straight chain or branched configuration, with an average of up to 25 moles of ethylene oxide per more of alcohol. Particularly preferred are the condensation products of alcohols having an alkyl group containing from about 9 to 15 carbon atoms with from about 2 to 10 moles of ethylene oxide per mole of alcohol; and condensation products of propylene glycol with ethylene oxide. Most preferred are condensation products of alcohols having an alkyl group containing from about 12 to 15 carbon atoms with an average of about 3 moles of ethylene oxide per mole of alcohol.

Other suitable surfactants according to the present invention includes also cationic, ampholytic, zwitterionic, and semi-polar surfactants, as well as nonionic surfactants other than those already described herein, including the semi-polar nonionic amine oxides described below.

Ampholytic surfactants are also suitable for use in the laundry detergent compositions of the present invention. These surfactants can be broadly described as aliphatic derivatives of secondary or tertiary amines, or aliphatic derivatives of heterocyclic secondary and tertiary amines in which the aliphatic radical can be straight- or branched chain. One of the aliphatic substituents contains at least 8 carbon atoms, typically from about 8 to about 18 carbon atoms, and at least one contains an anionic water-solubilizing group e.g. carboxy, sulfonate, sulfate. See U.S. Pat. No. 3,929,678 to Laughlin et al., issued Dec. 30, 1975 at column 19, lines 18-35 (herein incorporated by reference) for examples of ampholytic surfactants.

Zwitterionic surfactants are also suitable for use in laundry detergent compositions. These surfactants can be broadly described as derivatives of secondary and tertiary amines, derivates of heterocyclic secondary and tertiary amines, or derivatives of quaternary ammonium, quarternary phosphonium or tertiary sulfonium compounds. See U.S. Pat. No. 3,929,678 to Laughlin et al., issued Dec. 30, 1975 at columns 19, line 38 through column 22, line 48 (herein incorporated by reference) for examples of zwitterionic surfactants.

Semi-polar nonionic surfactants are a special category of nonionic surfactants which include water-soluble amine oxides containing one alkyl moiety of from about 10 to about 18 carbon atoms and 2 moieties selected from the group consisting alkyl groups and hydroxyalkyl groups containing form about 1 to about 3 carbon atoms; water-soluble phosphonic oxides containing one alkyl moiety of form about 10 to about 18 carbon atoms and 2 moieties selected form the group consisting of alkyl groups and hydroxyalkyl groups containing from about 1 to about 3 carbon atoms. Semi-polar nonionic detergent surfactants include the amine oxide surfactants having the formula R³(OR⁴)ₓNO(R⁵)₂

### Fillers

The compositions of the present invention may comprise a filler salt as a highly preferred though option ingredient. Suitable filler salts herein are selected from the group consisting of sodium sulfate, sodium chloride, sodium tripolyphosphate “STPP” and the like. Typically, the compositions according to the present invention may comprise from up to 75% by weight of the total composition of a filler salt or a mixture thereof, preferably from 70% to 10% and more preferably from 60% to 30%.

### Chelating Agents

The compositions of the present invention may comprise a chelating agent as an optional ingredient. Typically, the compositions according to the present invention comprise up to 5% by weight of the total composition of a chelating agent, or mixtures thereof, preferably from 0.01% to 1.5% by weight and more preferably from 0.01% to 0.5%.

Suitable phosphonate chelating agents for use herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

### Anti-Redeposition Polymer

The compositions according to the present invention may further comprise an anti-redeposition polymer or mixtures thereof, as an optional ingredient.

Suitable anti-redeposition polymers include polymeric polycarboxylates and: polyacrylates polymers, preferably having a weight average molecular weight of from 1,000 Da to 20,000 Da. Suitable anti-redeposition polymers include also co-polymers of maleic acid and acrylic acid, preferably having a molar ratio of maleic acid monomers to acrylic acid monomers of from 1:1 to 1:10 and a weight average molecular weight of from 10,000 Da to 200,000 Da, or preferably having a molar ratio of maleic acid monomers to acrylic acid monomers of from 0.3:1 to 3:1 and a weight average molecular weight of from 1,000 Da to 50,000 Da. Suitable polycarboxylates are the Sokalan CP, PA and HP ranges (BASF) such as Sokalan CP5, PA40 and HP22, and the Alcosperse range of polymers (Alco) such as Alcosperse 725, 747, 408, 412 and 420.

Further suitable anti-redeposition polymers include cellulose derivatives, for example carboxymethyl cellulose, methylhydroxyethyl cellulose, and mixtures thereof. An example of a suitable carboxymethylcellulose is Finnfix® BDA, supplied by CPKelco, Arhem, Netherlands. An example of suitable methylhydroxymethyl cellulose is Tylose® MH50 G4, supplied by SE Tylose GmbH, Wiesbaden, Germany.

Further suitable anti-redeposition polymers include polyamine polymers known to those skilled in the art. Particularly suitable polyamine polymers for use herein are polyalkoxylated polyamines.

Typically, the compositions comprise up to 10% by weight of the total composition of such a soil suspending polyamine polymer or mixtures thereof, preferably from 0.1% to 5% and more preferably from 0.3% to 2%.

The compositions herein may also comprise other polymeric soil release agents known to those skilled in the art. Such polymeric soil release agents are characterized by having both hydrophilic segments, to hydrophilize the surface of hydrophobic fibers, such as polyester and nylon, and hydrophobic segments, to deposit upon hydrophobic fibers and remain adhered thereto through completion of washing and rinsing cycles and, thus, serve as an anchor for the hydrophilic segments. This can enable stains occurring subsequent to treatment with the soil release agent to be more easily cleaned in later washing procedures.

If utilized, soil release agents will generally comprise from 0.01% to 10.0%, by weight, of the compositions herein, typically from 0.1% to 5%, preferably from 0.2% to 3.0%.

### Dye Transfer Inhibitor

The compositions of the present invention may also include one or more materials effective for inhibiting the transfer of dyes from one dyed surface to another during the cleaning process. Generally, such dye transfer inhibiting agents include polyvinyl pyrrolidone polymers, polyamine N-oxide polymers, co-polymers of N-vinylpyrrolidone and N-vinylimidazole, manganese phthalocyanine, peroxidases, and mixtures thereof. If used, these agents typically comprise from 0.01% to 10% by weight of the composition, preferably from 0.01% to 5%, and more preferably from 0.05% to 2%.

### Brightener

Any optical brighteners, fluorescent whitening agents or other brightening or whitening agents known in the art can be incorporated in the instant compositions when they are designed for fabric treatment or laundering, at levels typically from about 0.05% to about 1.2%, by weight, of the compositions herein.

### Processes of Treating Fabrics

The present invention encompasses a process of treating fabrics which comprises the steps of forming an aqueous bath comprising water, a conventional laundry detergent, preferably a granular laundry detergent, and a particulate bleach additive composition according to the present invention, and subsequently contacting said fabrics with said aqueous bath.

The process of treating, preferably bleaching, fabrics according to the present invention delivers effective whiteness performance as well as effective stain removal and stain release performance. The term ‘stain release’ refers to the ability of the composition to modify the surfaces of the textile over multiple wash cycles resulting in reduced adhesion of soils.

The process of treating fabrics herein comprises the steps of forming an aqueous bath comprising water, a conventional laundry detergent and a particulate bleach additive composition, as described herein, subsequently contacting said fabrics with said aqueous bath.

By “conventional laundry detergent” it is meant herein, a laundry detergent composition currently available on the market. Preferably, said conventional laundry detergent comprises at least one surfactant. Said laundry detergent compositions may be formulated as particulates (including powders, pearls, granules, tablets and the like), liquids (liquids, gels, and the like) as well as detergent forms based on water-soluble or water-permeable pouches comprising liquids and/or particulates (such as liquid-tabs). Suitable particulate laundry detergent compositions are for example DASH Powder®, ARIEL Tablets®, ARIEL Powder® and other products sold under the trade names ARIEL® or TIDE®.

In a preferred embodiment herein, the conventional laundry detergent is a conventional particulate laundry detergent more preferably a conventional powder, pearl, granule or tablet laundry detergent.

In a preferred embodiment according to the present invention, the conventional laundry detergent as described herein and, the particulate bleach additive composition herein are dissolved or dispersed, preferably substantially dissolved or dispersed, in the aqueous bath formed in the process according to the present invention. By “substantially dissolved or dispersed” it is meant herein, that at least 50%, preferably at least 80%, more preferably at least 90%, even more preferably at least 95%, still more preferably at least 98%, and most preferably at least 99%, of said conventional laundry detergent and/or said particulate bleach additive composition are dissolved or dispersed in the aqueous bath formed in the process according to the present invention.

The particulate bleach additive composition and the conventional detergent composition may be delivered into the washing machine either by charging the dispenser drawer of the washing machine with one or both of the detergents or by directly charging the drum of the washing machine with one or both of the detergents. More preferably the particulate bleach additive composition is directly placed into the drum of the washing machine, preferably using a dosing device, such as a dosing ball (such as the Vizirette®). Even more preferably the particulate bleach additive composition and the conventional detergent composition are both placed into the drum of the washing machine, preferably using suitable dosing devices such as dosing balls, dosing nets etc. The particulate bleach additive composition is preferably delivered to the main wash cycle of the washing machine before, but more preferably at the same time as the conventional detergent composition.

During the processes according to the present invention the particulate bleach additive compositions herein is typically used in dissolved form. By “in dissolved form”, it is meant herein that the particulate bleach additive compositions according to the present invention may be dissolved by the user, preferably in water. The dissolution occurs in a washing machine. Said compositions can be dissolved up to 500 times its own weight, preferably from 5 to 350 times and more preferably from 10 to 200 times.

### Example

The following examples further illustrate the present invention. The compositions are made by combining the listed ingredients in the listed proportions (weight % active material except in the case of Mannanase, Protease and Cellulase which refers to the % of enzyme granulate). The following Examples are meant to exemplify compositions according to the present invention but are not necessarily used to limit or otherwise define the scope of the present invention.

All compositions Ito IV are packaged in a carton made from high density polyethylene having an average thickness of 2.5 mm. The packaging system has a Moisture Vapor Transfer Rate less than 0.11 g/m²/day. These compositions exhibit excellent bleaching performances and do not generate malodors even upon storage.

| Ingredients | I | II | III | IV |
|---|---|---|---|---|
| Sodium percarbonate | 33.0 | 38.3 | 18.0 | 30.0 |
| TAED | — | 9.0 | 4.4 | 4.0 |
| NOBS | 15.0 | 6.7 | 6.6 | 6.7 |
| Polyamine polymer | 6.0 | — | — | 6.0 |
| Acrylic Acid/Maleic Acid | 2.0 | — | — | — |
| Copolymer | | | | |
| HEDP | 1.3 | — | 1.2 | — |
| Carboxymethyl cellulose | — | 0.1 | 0.5 | — |
| Polyvinylpyrrolidone (PVP) | — | 0.2 | 0.1 | — |
| Anionic (LAS) surfactant | 1.2 | 4.5 | 3.7 | — |
| Nonionic (AE7) surfactant | 0.5 | 1.0 | 0.4 | 0.1 |
| Sodium lauroyl sarcosinate | — | 1.0 | | — |
| surfactant | | | | |
| Sodium xylene sulfonate | — | 1.1 | — | — |
| (hydrotrope) | | | | |
| Mannanase granulate | 0.2 | — | 0.1 | — |
| Protease granulate | — | 0.5 | 0.1 | — |
| Cellulase granulate | 0.2 | 0.2 | 0.1 | 0.1 |
| Brightener | 0.1 | — | 0.07 | — |
| Soil release agent | — | — | 0.56 | — |
| Sodium carbonate | Balance | Balance | Balance | Balance |

Sodium percarbonate is S222 available from Solvay.
TAED is tetraacetylethylenediamine, Peractive ®, available from Clariant GmbH
Nobs is sodium n-nonyloxybenzene sulfonate
Polyamine polymer is bis((C₂H₅O)(C₂H₄O)ₙ)(CH₃)—N⁺—CₓH₂ₓ—N⁺—(CH₃)—bis((C₂H₅O)(C₂H₄O)ₙ), wherein n = from 20 to 30, and x = from 3 to 8.
Acrylic acid/maleic acid copolymer is an acrylate/maleate copolymer with a ratio 70:30 and molecular weight of 70000, available from BASF.
HEDP is hydroxyethane diphosphonate available from Dow Chemical.
Carboxymethyl cellulose is Finnfix ® GDA available from CPKelco, (NL).
Polyvinylpyrrolidone is PVP-K15 available from ISP Corporation (NJ, USA).
Anionic (LAS) is sodium alkylbenzenesulfonate having an average aliphatic carbon chain length C₁₁-C₁₂ available from Stepan (USA).
Nonionic (AE7) is C₁₂-C₁₅ alcohol ethoxylate, with an average degree of ethoxylation of 7, available from Huntsman, (Utah, USA).
Sodium lauroyl sarcosinate is Hamposyl L95, available from Chattern Chemicals, (Tennessee, USA).
Sodium xylene sulfonate is available from Stepan, (Illinois, USA).
Mannanase granulate is Mannaway available from Novozymes (Denmark) and contains 4 mg active enzyme per gram.
Protease granulate is Savinase, available from Novozymes (Denmark) and contains 15.8 mg active enzyme per gram.
Cellulase granulate is Celluclean, available from Novozymes (Denmark) and contains 15.6 mg active enzyme per gram.
Brightener is Tinopal ® CBS-X available from Ciba Specialty Chemicals, (Switzerland).
Soil release agent is Repel-o-tex ® SF2, available from Rhodia (France).
Sodium carbonate is available from Solvay.

### Data

NOBS stability was assessed over time. As NOBS decomposed, the more malodour was generated. Compositions according to the examples were prepared and placed into various packages, having various Moisture Vapor Transfer Rates.

Samples were made according to Example II and stored for 8 weeks at 32° C. at 80% relative humidity. This ‘accelerated aging’ test replicates storage of samples at 21° C. for 16 months. This is the amount of time that product could potentially be stored prior to use. For example, it could be stored in warehouses, distribution centers and consumer homes. Hence it must still exhibit adequate bleaching performance following storage under the test conditions.

A minimum of 80% NOBS recovery is necessary to ensure consumer accepted bleaching performance (adequate removal of stains from fabrics).

As can be seen from Table 1, a Moisture Vapor Transfer Rate of less than 0.1 g/m²/day is necessary to ensure a minimum of 80% NOBS recovery following the storage test.

| Moisture Vapor | % NOBS recovery |
|---|---|
| Transfer Rate | following 8 weeks at 32° C., |
| (g/m²/day) | 80% relative humidity |
| 0 | 100 |
| 0.025 | 97 |
| 0.05 | 92 |
| 0.075 | 88 |
| 0.1 | 82 |
| 0.125 | 77 |
| 0.15 | 72 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A packaged particulate bleaching composition, the composition comprising:
a. from about 1% to about 30% by weight of a bleach activator, and
b. from about 10% to about 80% by weight of an oxygen bleach,
wherein the composition is packaged in a packaging system having a Moisture Vapour Transfer Rate of less than about 0.1 g/m²/day as measured by ASTM Standard E-96-53T.

2. The packaged composition according to claim 1, wherein the bleach activator has the formula: 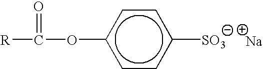
wherein R is an alkyl chain, linear or branched, containing from 1 to 11 carbon atoms.

3. The packaged composition according to claim 1, wherein the bleach activator has the formula:

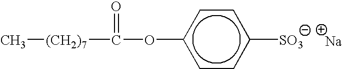

4. The packaged composition according to claim 1, wherein the composition comprises from 2% to 20% by weight of the total composition of bleach activators.

5. The packaged composition according to claim 1, wherein the composition comprises from 15% to 70% by weight of the total composition of oxygen bleach.

6. The packaged composition according to claim 1, wherein the oxygen bleach is a peroxygen source.

7. The packaged composition according to claim 1, wherein the packaging system is made of thermoplastic materials,

8. The packaged composition according to claim 7, wherein the packaging system is made of high density polyethylene (HDPE).

9. The packaged composition according to claim 1, wherein the packaging system has a closure mechanism comprising a nozzle section and a cap section joint together by hinges.

10. The packaged composition according to claim 1, wherein the composition further comprises a surfactant system selected from any of nonionic, anionic, zwitterionic, cationic and/or amphoteric surfactants or mixture thereof.

11. A process of packaging a composition to reduce the production of malodorous decomposition products from the composition comprising:
a. from about 1% to about 30% by weight of a bleach activator, and
b. from about 10% to about 80% by weight of an oxygen bleach,
wherein the composition is packaged in a packaging system having a Moisture Vapour Transfer Rate of less than about 0.1 g/m²/day as measured by ASTM Standard E-96-53T.
